(19) United States
(12) Patent Application Publication
(10) Pub. No.: US 2010/0026737 A1
(43) Pub. Date: Feb. 4, 2010

(54) Video Display Device

(75) Inventors: Tomotaka Ida, Saitama (JP); Munehiro Terada, Saitama (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/398,082

(22) Filed: Mar. 4, 2009

(30) Foreign Application Priority Data
Aug. 4, 2008 (JP) 2008-201136

(51) Int. Cl. G09G 5/391; H04N 7/01

(52) U.S. Cl. 345/698; 348/441

(57) ABSTRACT

According to one embodiment, a video display device includes a super resolution converter, a moving-image improving module, and a demonstration mode controller. The super resolution converter performs, on receipt of a first video signal with first resolution, super resolution conversion on the first video signal to obtain a second video signal with second resolution that is higher than the first resolution. The moving-image improving module performs moving-image improvement on the second video signal to double the frames of video per second. The demonstration mode controller controls activation of first demonstration mode for displaying, on a display module, demonstration related to the super resolution conversion and second demonstration mode for displaying demonstration related to the moving-image improvement.

### CROSS-REFERENCE TO RELATED APPLICATIONS

This application is based upon and claims the benefit of priority from Japanese Patent Application No. 2008-201136, filed Aug. 4, 2008, the entire contents of which are incorporated herein by reference.

### BACKGROUND

1. Field

One embodiment of the invention relates to a video display device that operates in a plurality of demonstration modes.

2. Description of the Related Art

Demo mode is short for “demonstration mode” and is often found on video display devices such as liquid crystal television. The demo mode is usually activated to demonstrate the features of a device in question for in-store advertising and display images obtained by applying various types of processing to the original image on its screen. The demo mode allows customers to visually check the difference between the images.

For example, Japanese Patent Application Publication (KOKAI) No. 2001-242980 discloses an information display system as a conventional technology related to the demo mode. In the information display system, the time for which information is displayed in the demo mode or the type of scrolling changes according to the content of the information displayed in the demo mode.

Besides, as a new technology for improving the resolution of video, a super resolution conversion function has recently been employed in video display devices. The super resolution conversion function interpolates new pixel value data between pixels to generate high frequency components, thereby creating an image having a resolution higher than that of the original image.

On the other hand, there has not yet been proposed the demo mode capable of demonstrating the features of the super resolution conversion function, let alone the method of effectively using the demo mode for demonstrating the features of the super resolution conversion function and that for demonstrating the features of other functions.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a video display device according to a first embodiment of the invention;

FIG. 2 is an exemplary block diagram of a video processor in the first embodiment;

FIG. 3 is an exemplary flowchart of a process of demo mode control performed by the video display device in the first embodiment;

FIG. 4 is an exemplary schematic diagram of an image displayed in demo mode A on the screen of a display module in the first embodiment;

FIG. 5 is an exemplary schematic diagram of an image displayed in demo mode B on the screen of the display module in the first embodiment;

FIG. 6 is an exemplary schematic diagram of a standard screen displayed on the display module in the first embodiment;

FIG. 7 is an exemplary flowchart of a process of demo mode control performed by a video display device according to a second embodiment of the invention;

FIG. 8 is an exemplary schematic diagram of an image displayed in demo mode A (scrolling demonstration) on the screen of a display module in the second embodiment;

FIG. 9 is an exemplary schematic diagram of a screen displayed on the screen of the display module for selecting a demo mode in a third embodiment of the invention; and

FIG. 10 is an exemplary flowchart of a process of demo mode control performed by a video display device according to the third embodiment.

### DETAILED DESCRIPTION

Various embodiments according to the invention will be described hereinafter with reference to the accompanying drawings. In general, according to one embodiment of the invention, a video display device comprises: a super resolution converter configured to perform, on receipt of a first video signal with first resolution, super resolution conversion on the first video signal to obtain a second video signal with second resolution that is higher than the first resolution by estimating an original pixel value from the first video signal and increasing pixels; a moving-image improving module configured to perform moving-image improvement on the second video signal by high-precision motion interpolation to double frames of video per second; and a demonstration mode controller configured to control activation of demonstration modes, the demonstration modes including first demonstration mode for displaying demonstration related to the super resolution conversion on a display module and second demonstration mode for displaying demonstration related to the moving-image improvement on the display module.

According to another embodiment of the invention, a video display device comprises: a super resolution converter configured to perform, on receipt of a first video signal with first resolution, super resolution conversion on the first video signal to obtain a second video signal with second resolution that is higher than the first resolution by estimating an original pixel value from the first video signal and increasing pixels; and a demonstration mode controller configured to control activation of demonstration mode for displaying demonstration related to the super resolution conversion on a display module.

According to still another embodiment of the invention, a video display device comprises: a super resolution converter configured to perform, on receipt of a first video signal with first resolution, super resolution conversion on the first video signal to obtain a second video signal with second resolution that is higher than the first resolution; a moving-image improving module configured to perform moving-image improvement on the second video signal by high-precision motion interpolation to double frames of video per second; and a demonstration mode controller configured to control activation of first demonstration mode for displaying demonstration related to the super resolution conversion on a display module and second demonstration mode for displaying demonstration related to the moving-image improvement on the display module.

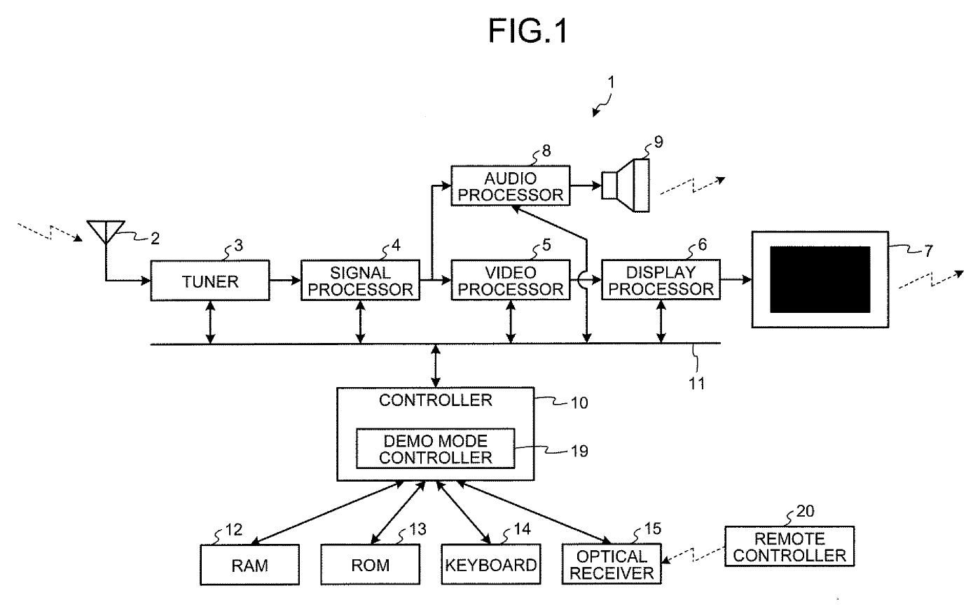

FIG. 1 is a block diagram of a video display device 1 according to a first embodiment of the invention. Although the video display device is described below as being applied to a television, this is by way of example only and does not imply any limitation. The video display device 1 comprises an antenna 2, a tuner 3, a signal processor 4, a video processor 5, a display processor 6, a display module 7, an audio processor 8, a speaker 9, a controller 10, a communication line 11, a RAM 12, a ROM 13, a keyboard 14, and an optical receiver 15.

The antenna 2 receives digital broadcasting such as BS broadcasting, CS broadcasting, and digital terrestrial broadcasting. The tuner 3 selects a channel to view specified by a user. The signal processor 4 acquires demodulated signals as various digital signals and processes them.

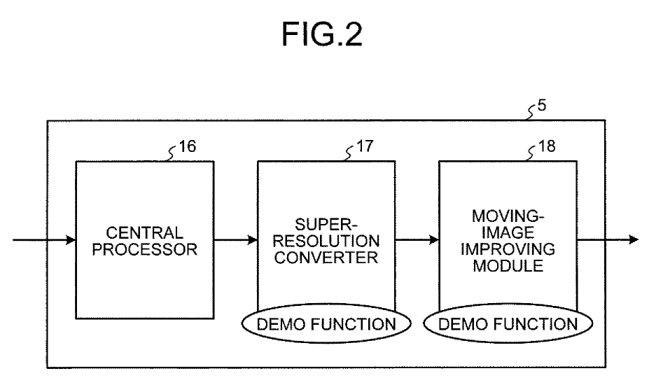

The video processor 5 adjusts the screen size of an image represented by a video signal received from the signal processor 4, and also performs various types of video processing on it. FIG. 2 is a block diagram of the video processor 5 for illustrating detailed functions thereof. The video processor 5 comprises a central processor 16, a super-resolution converter 17, and a moving-image improving module 18.

The central processor 16 performs processing, such as interlace/progressive (IP) conversion, noise reduction (NR) processing, and scaling, on the video signal.

The super-resolution converter 17 performs super resolution conversion on the video signal. The term “super resolution conversion” as used herein refers to image sharpening, in which, from an image signal with low resolution, i.e., first resolution, an original pixel value is estimated to increase the pixels and thus to restore an image signal with high resolution, i.e., second resolution.

The term “original pixel value” as used herein refers to the value of each pixel of an image signal obtained by, for example, photographing the same object as that of an image with the first resolution using a camera having high-resolution pixels and capable of capturing an image with the second resolution.

Besides, “original pixel value is estimated to increase the pixels” means to obtain the characteristics of images to find a correlated image, and estimate an original pixel value from neighboring images (in the same frame or between frames) using the correlated image to increase the pixels.

By performing such processing on the video signal, an image having a resolution higher than that of the original video signal can be generated and displayed on the display module 7. The super resolution conversion may be performed using known or commonly used technologies as disclosed in, for example, Japanese Patent Application Publication (KOKAT) Nos. 2007-310837, 2008-98803, and 2000188680. In the following, the super resolution conversion uses a technology of, for example, restoring an image with frequency components above the Nyquist frequency determined by the sampling rate of an input image.

If employing the super resolution conversion disclosed in Japanese Patent Application Publication (KOKAI) No. 2007-310837, the super-resolution converter 17 sets a target pixel in each of a plurality of low-resolution image signals (image data), and sets a target image area so that it contains the target pixel. The super-resolution converter 17 selects a plurality of correspondent points that correspond to a plurality of target image areas closest to a variation pattern of the pixel value in the target image area from a reference image signal (image data). The super-resolution converter 17 sets a sample value of luminance of a correspondent point to the pixel value of a corresponding target pixel. The super-resolution converter 17 calculates a pixel value for a high-resolution image signal (image data) having more pixels than the reference image signal (image data) and corresponding to the reference image signal (image data) based on the size of a plurality of sample values and layout of the correspondent points. Thus, the super-resolution converter 17 estimates an original pixel value from a low-resolution image signal, and increases the pixels to restore a high-resolution image signal.

If employing the super resolution conversion using self-congruency position search in the same image signal (image data) disclosed in Japanese Patent Application Publication (KOKAI) No. 2008-98803, the super-resolution converter 17 calculates a first pixel position with the smallest error, i.e., a first error, by comparing errors of respective pixels in a search area of a low-resolution image signal (image data). The super-resolution converter 17 calculates a position with the smallest error in the search area with decimal precision based on the first pixel position and the first error, and a second pixel position around a first pixel and a second error thereof. The super-resolution converter 17 calculates a decimal-precision vector that has its end point at the position with the smallest error and its start point at a pixel of interest. The super-resolution converter 17 calculates an extrapolation vector of the decimal-precision vector that has its end point at a pixel on a screen which is not in the search area based on the decimal-precision vector. The super-resolution converter 17 calculates a pixel value for a high-resolution image having more pixels than image data based on a pixel value obtained from the image data, the decimal-precision vector, and the extrapolation vector. In this manner, the super-resolution converter 17 estimates an original pixel value from a low-resolution image signal, and increases the pixels to restore a high-resolution image signal.

The super-resolution converter 17 may employ the super resolution conversion disclosed in Japanese Patent Application Publication (KOKAI) No. 2000-188680 using mapping between a plurality of image signals (image data).

The above technologies of the super resolution conversion are cited by way of example and not by way of limitation. The super-resolution converter 17 may employ various other technologies in which an original pixel value is estimated from a low-resolution image signal to increase the pixels to thereby obtain a high-resolution image signal.

The moving-image improving module 18 performs moving-image improvement on the video signal. The term “moving-image improvement” refers to video signal processing of reproducing video with a frame rate of 60 frames per second (fps) as that with a frame rate of 120 fps through a high precision motion interpolation technology. Such video signal processing reduces image blur in a portion in which an object moves horizontally, vertically, and diagonally or rotates as well as efficiently suppressing noise. Thus, a telop sequence, a sports scene with fast motion, etc. can be displayed clearly on the display module 7.

The display processor 6 superimposes graphics such as text data on the video signal after the processing. The display module 7 displays the video signal on the screen. Thus, the user views a television image on the screen of the display module 7. The audio processor 8 performs audio processing on an audio signal as well as amplifying the audio signal. The speaker 9 outputs the audio signal as audio. Thus, the user listens to television sound from the speaker 9.

The controller 10 controls the tuner 3, the signal processor 4, the video processor 5, the display processor 6, and the audio processor 8. A microcomputer may be a specific example of the controller 10. The controller 10 comprises a demo mode controller 19.

The demo mode controller 19 controls demo mode. The demo mode of the video display device 1 includes two types of demo modes, i.e., demo mode A and demo mode B. In the demo mode A, an original image is displayed with an image obtained by performing the super resolution conversion on the original image, for example, side by side on the display module 7. Meanwhile, in the demo mode B, an original image is displayed with an image obtained by performing the moving-image improvement on the original image, for example, side by side on the display module 7. The demo mode controller 19 controls the demo mode such that the demo mode A presents the static display while the demo mode B presents the scrolling display.

The communication line 11 interconnects the tuner 3, the signal processor 4, the video processor 5, the display processor 6, the audio processor S, and the controller 10 to enable data exchange among them. An inter-integrated circuit (IIC) bus may be a specific example of the communication line 11.

The RAM 12 and the ROM 13 store various types of data and exchange them with the controller 10. Specifically, the ROM 13 stores still image data A and still image data B. The still image data A herein represents a still image (JPEG) for use in the demo mode A that is smaller than the full high-definition size (1920×1080). The still image data B herein represents a still image (JPEG) for use in the demo mode B that is in the full high-definition size (1920×1080).

The keyboard 14 is used to input various instructions to the video display device 1. The optical receiver 15 receives a signal that a remote controller 20 issues in response to an instruction from the user.

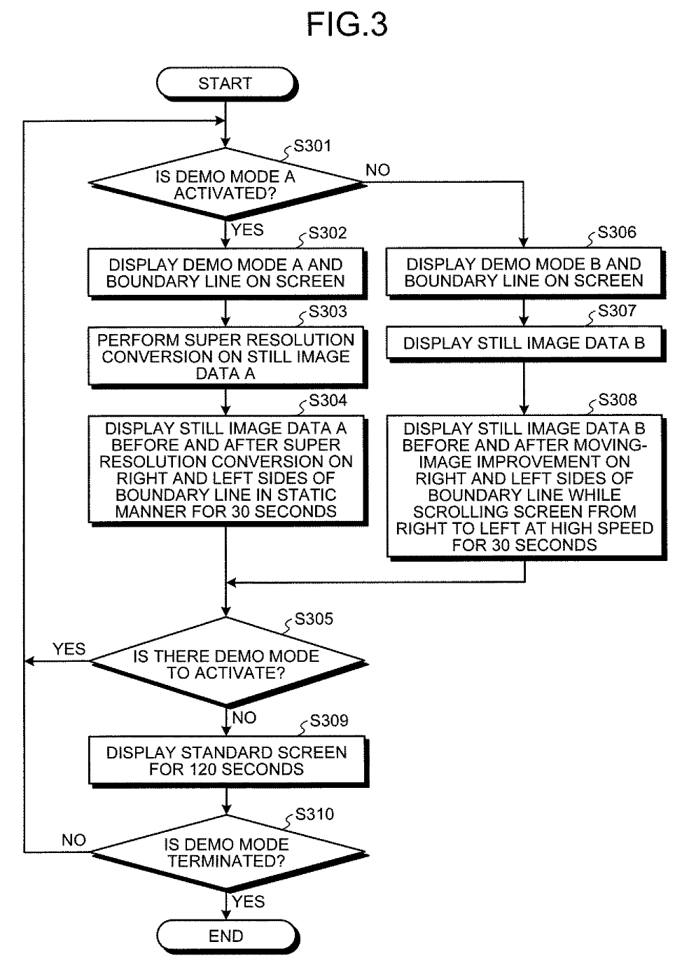

A description will be given of how the video display device 1 displays video in the demo mode. FIG. 3 is a flowchart of a process of demo mode control performed by the video display device 1. The demo mode is activated in response to a start instruction from a salesperson or a customer. The demo mode may be automatically activated by preset “Auto Demo Mode”.

First, the demo mode controller 19 determines whether to activate the demo mode A (S301). Upon determining to activate the demo mode A (Yes at S301), the demo mode controller 19 instructs the display processor 6 to display the type of the demo mode, i.e., “Demo Mode A”, and a boundary line on the screen of the display module 7 (S302). For specific example, the display processor 6 displays “Demo Mode A” in the upper center of the screen and a boundary line that equally divides the screen into right and left halves. Further, the display processor 6 displays “OFF” on the lower part of the right half of the screen and “ON” on the lower part of the left half of the screen. On the screen indicating “OFF” is displayed an image not having undergone the super resolution conversion. On the screen indicating “ON” is displayed an image having undergone the super resolution conversion.

The demo mode controller 19 then instructs the super-resolution converter 17 to perform the super resolution conversion on the still image data A (S303). More specifically, the super-resolution converter 17 performs the super resolution conversion to increase the size of the still image data A stored in the ROM 13 to the full high-definition size (1920×1080).

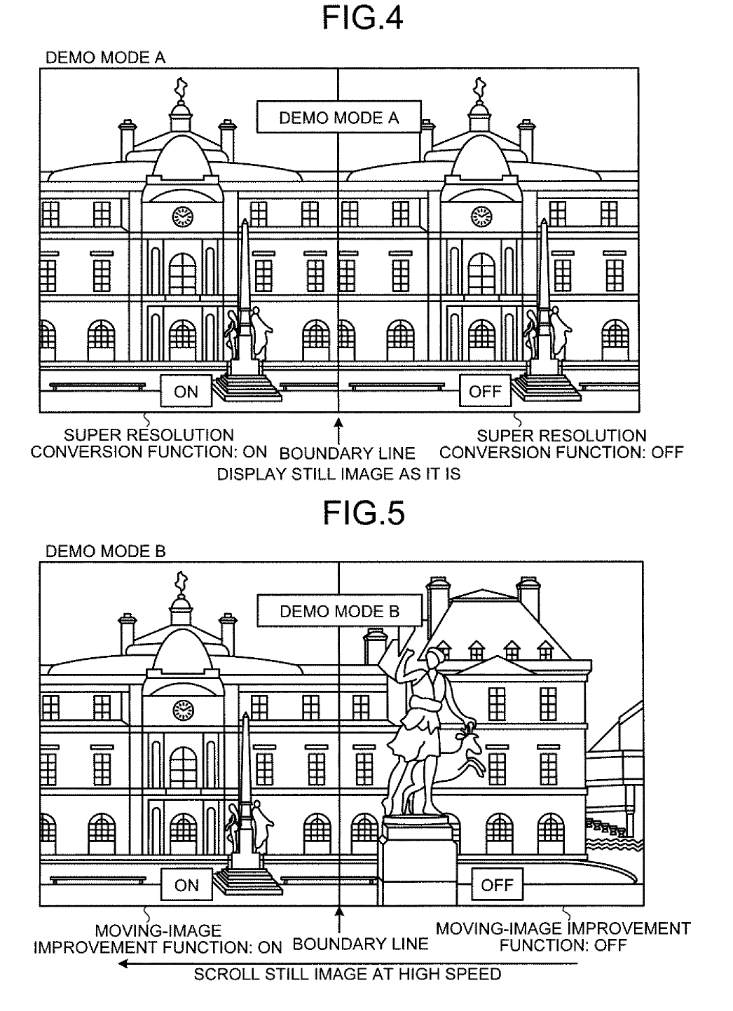

Thereafter, the demo mode controller 19 instructs the video processor 5 to display the still image data A before the super resolution conversion on the right side of the boundary line on the screen in a static manner for 30 seconds. Similarly, the demo mode controller 19 instructs the video processor 5 to display the still image data A after the super resolution conversion on the left side of the boundary line on the screen in a static manner for 30 seconds (S304). FIG. 4 illustrates an example of images displayed in the demo mode A on the screen of the display module 7.

In FIG. 4, the still image on the right side of the boundary line is half the size of an image obtained by scaling the still image data A to the full high-definition size (1920×1080), i.e., of an image size of 960×1080 pixels. The still image on the left side of the boundary line is half the size of an image obtained by scaling the still image data A to the full high-definition size (1920×1080), i.e., of an image size of 960×1080 pixels, and also performing the super resolution conversion thereon. The still images of the same portion are displayed on the right and left sides of the boundary line, respectively.

In this manner, still images of the same portion, one having undergone the super resolution conversion and the other not, are concurrently displayed side by side on the same screen. This allows customers to easily check the difference between the images.

After 30-second static display of the still image data A, the demo mode controller 19 determines whether there is demo mode to activate (S305). At this point, since the demo mode B is yet to be activated, the demo mode controller 19 determines that there is demo mode to activate (Yes at S305), and the process returns to S301.

Upon determining not to activate the demo mode A, i.e., to activate the demo mode B (No at S301), the demo mode controller 19 instructs the display processor 6 to display the type of the demo mode, i.e., “Demo Mode B”, and a boundary line on the screen of the display module 7 (S306). For specific example, the display processor 6 displays “Demo Mode B” in the upper center of the screen and a boundary line that equally divides the screen into right and left halves. Further, the display processor 6 displays “OFF” on the lower part of the right half of the screen and “ON” on the lower part of the left half of the screen. On the screen indicating “OFF” is displayed an image not having undergone the moving-image improvement. On the screen indicating “ON” is displayed an image having undergone the moving-image improvement.

Thereafter, the demo mode controller 19 instructs the video processor 5 to display the still image data B ($307).

The demo mode controller 19 then instructs the moving-image improving module 18 to perform the moving-image improvement on the still image data B to display an image. Accordingly, half of the image is displayed in a state before the moving-image improvement on the right side of the boundary line on the screen, while the other half is displayed in a state after the moving-image improvement on the left side thereof. The image is displayed as being scrolled from right to left at high speed for 30 seconds (S308). FIG. 5 illustrates an example of an image displayed in the demo mode B on the screen of the display module 7.

In FIG. 5, part of the still image on the right side of the boundary line is half the size of an image represented by the still image data B, i.e., of an image size of 960×1080 pixels. Part of the still image on the left side of the boundary line is half the size of an image represented by the still image data B, i.e., of an image size of 960×1080 pixels, having undergone the moving-image improvement. The right and left halves separated by the boundary line form, in combination, an image of the still image data B in the full high-definition size (1920×1080). While the still image data B is scrolling from right to left, the portion of the image that disappears to the left of the screen appears again from the right. Since the moving-image improvement is effective for fast motion, the screen is scrolled at high speed. The display of “Demo Mode B”, the boundary line, “ON” and “OFF” is independent of the scrolling of the still image data B, and is fixed on the screen.

In this manner, the display state of a still image changes from before to after the moving-image improvement at the boundary line on the screen being scrolled. This allows customers to easily check the difference between the display states.

After 30-second scrolling display of the still image data B, the demo mode controller 19 determines whether there is demo mode to activate (S305). At this point, since both the demo modes A and B have already been completed, the demo mode controller 19 determines that there is no demo mode to activate (No at S305), and the process moves to S309.

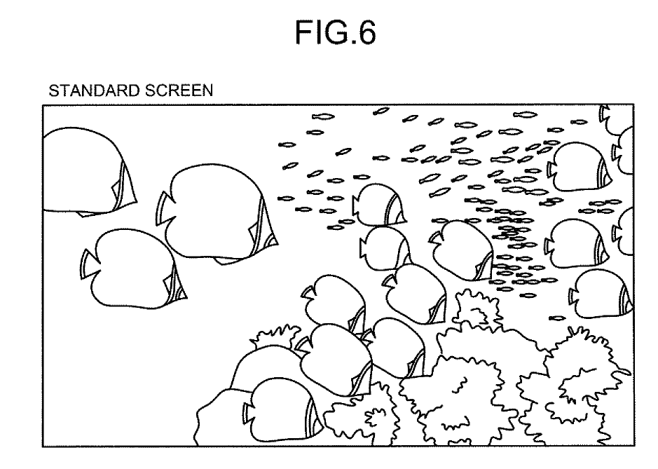

The demo mode controller 19 instructs the video processor 5 to display a standard screen on the screen for 120 seconds (S309). FIG. 6 illustrates an example of the standard screen displayed on the screen of the display module 7. After 120-second display of the standard screen, the process moves to S310.

The demo mode controller 19 determines whether to terminate the demo mode (S310). The demo mode controller 19 makes the determination based on, for example, whether a predetermined time has elapsed. If the demo mode controller 19 determines to terminate the demo mode (Yes at S310), the process ends. On the other hand, if the demo mode controller 19 determines not to terminate the demo mode (No at S310), the process returns to S301, and the demo mode continues.

As described above, according to the first embodiment, the demo mode controller controls the demo mode related to the super resolution conversion as well as the demo mode related to the moving-image improvement. Thus, both the demo modes can be effectively activated.

Moreover, the demo mode controller controls the demo mode related to the super resolution conversion. Thus, the demo mode related to the super resolution conversion can be effectively activated.

Furthermore, in the demo mode related to the super resolution conversion, the demo mode controller controls the demo mode such that still images of the same portion, one having undergone the super resolution conversion and the other not, are displayed side by side in a static manner. In the demo mode related to the moving-image improvement, the demo mode controller controls the demo mode to display a scrolling image so that the display state of the image changes from before to after the moving-image improvement. This facilitates to check the difference between the states of the image before and after the processing.

Next, a description will be given of the operation of the video display device I according to a second embodiment of the invention. In the second embodiment, the video display device 1 performs scroll display in the demo mode (demo mode A) for displaying an image after the super resolution conversion as in the demo mode (demo mode B) for displaying an image after the moving-image improvement.

That is, according to the second embodiment, the demo mode controller 19 of the controller 10 functions differently than in the first embodiment. More specifically, the demo mode controller 19 of the second embodiment controls the demo mode A to present the scrolling display as well as the static display, and controls the demo mode B to present the scrolling display. Otherwise, the video display device 1 of the second embodiment is of the same configuration and operates in a similar manner as previously described in the first embodiment, and the same description will not be repeated.

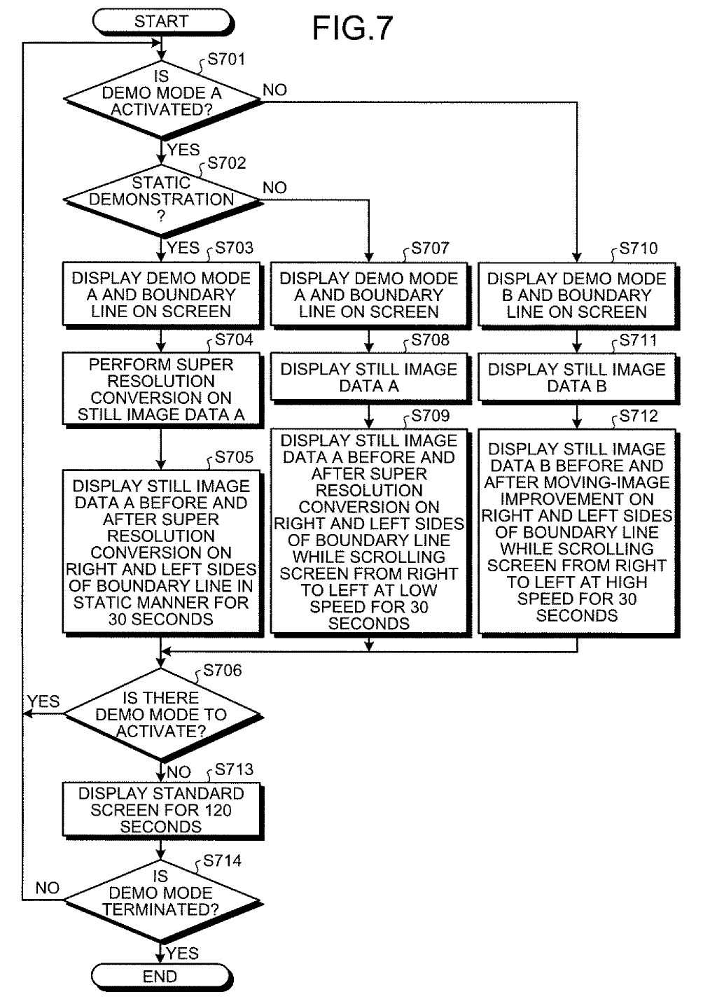

A description will be given of how the video display device 1 displays video in the demo mode according to the second embodiment. FIG. 7 is a flowchart of a process of demo mode control performed by the video display device 1 according to the second embodiment. The demo mode is activated in response to a start instruction from a salesperson or a customer. The demo mode may be automatically activated by preset “Auto Demo Mode”.

First, the demo mode controller 19 determines whether to activate the demo mode A (S701). Upon determining to activate the demo mode A (Yes at S701), the demo mode controller 19 further determines whether the demo mode A presents a static demonstration (S702).

Upon determining that the demo mode A presents a static demonstration (Yes at S702), the demo mode controller 19 instructs the display processor 6 to display the type of the demo mode, i.e., “Demo Mode A”, and a boundary line on the screen of the display module 7 (S703). For specific example, the display processor 6 displays “Demo Mode A” in the upper center of the screen and a boundary line that equally divides the screen into right and left halves. Further, the display processor 6 displays “OFF” on the lower part of the right half of the screen and “ON” on the lower part of the left half of the screen. On the screen indicating “OFF” is displayed an image not having undergone the super resolution conversion. On the screen indicating “ON” is displayed an image having undergone the super resolution conversion.

The demo mode controller 19 then instructs the super-resolution converter 17 to perform the super resolution conversion on the still image data A (S704). More specifically, the super-resolution converter 17 performs the super resolution conversion to increase the size of the still image data A stored in the ROM 13 to the full high-definition size (1920×1080).

Thereafter, the demo mode controller 19 instructs the video processor 5 to display the still image data A before the super resolution conversion on the right side of the boundary line on the screen in a static manner for 30 seconds. Similarly, the demo mode controller 19 instructs the video processor 5 to display the still image data A after the super resolution conversion on the left side of the boundary line on the screen in a static manner for 30 seconds (S705). Thus, images as described in the first embodiment in connection with FIG. 4 are displayed on the screen of the display module 7. After 30-second static display of the still image data A, the process moves to S706.

Upon determining that the demo mode A does not present a static demonstration, i.e., presents a scrolling demonstration (No at S702), the demo mode controller 19 instructs the display processor 6 to display the type of the demo mode, i.e., “Demo Mode A”, and a boundary line on the screen of the display module 7 (S707) For specific example, the display processor 6 displays “Demo Mode A” in the upper center of the screen and a boundary line that equally divides the screen into right and left halves. Further, the display processor 6 displays “OFF” on the lower part of the right half of the screen and “ON” on the lower part of the left half of the screen. On the screen indicating “OFF” is displayed an image not having undergone the super resolution conversion. On the screen indicating “ON” is displayed an image having undergone the super resolution conversion.

Thereafter, the demo mode controller 19 instructs the video processor 5 to display the still image data A (S708).

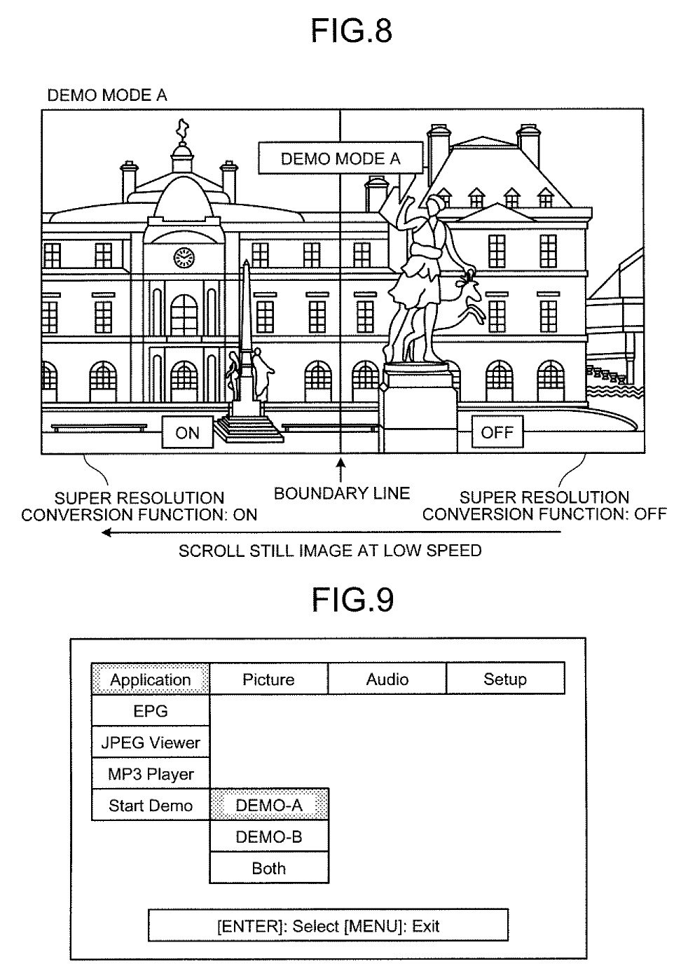

The demo mode controller 19 then instructs the super-resolution converter 17 to perform the super resolution conversion on the still image data A to display an image. Accordingly, half of the image is displayed in a state before the super resolution conversion on the right side of the boundary line on the screen, while the other half is displayed in a state after the super resolution conversion on the left side thereof. The image is displayed as being scrolled from right to left at low speed for 30 seconds (S109). FIG. 8 illustrates an example of an image displayed in the demo mode A (scrolling demonstration) on the screen of the display module 7.

In FIG. 8, part of the still image on the right side of the boundary line is half the size of an image represented by the still image data A expanded or scaled to the full high-definition size (1920×1080), i.e., of an image size of 960×1080 pixels. Part of the still image on the left side of the boundary line is half the size of an image represented by the still image data A expanded or scaled to the full high-definition size (1920×1080) i.e., of an image size of 960×1080 pixels, and having undergone the super resolution conversion.

The right and left halves separated by the boundary line form, in combination, an image of the still image data A expanded or scaled to the full high-definition size (1920×1080). While the still image data A is scrolling from right to left, the portion of the image that disappears to the left of the screen appears again from the right. Since the super resolution conversion is effective for slow motion, the screen is scrolled at low speed. The display of “Demo Mode A”, the boundary line, “ON” and “OFF” is independent of the scrolling of the still image data A, and is fixed on the screen.

In this manner, the display state of a still image changes from before to after the super resolution conversion at the boundary line on the screen being scrolled. This allows customers to easily check the difference between the display states.

After 30-second scrolling display of the still image data A, the process moves to S706. The demo mode controller 19 determines whether there is demo mode to activate (S706). At this point, since the demo mode B is yet to be activated, the demo mode controller 19 determines that there is demo mode to activate (Yes at S706), and the process returns to S701.

Upon determining not to activate the demo mode A, i.e., to activate the demo mode B (Yes at S701), the demo mode controller 19 instructs the display processor 6 to display the type of the demo mode, i.e., “Demo Mode B”, and a boundary line on the screen of the display module 7 (S710). The process from S711 to S714 is the same as the process from S307 to 310 of FIG. 3 previously described in the first embodiment, and the description will not be repeated.

According to the second embodiment, the still image data B for use in the demo mode B need not necessarily be in the full high-definition size (1920×1080). The still image data B may be the same as the still image data A for use in the demo mode A, i.e., smaller than the full high-definition size (1920×1080). In this case, the still image data B is required to be expanded or scaled to the full high-definition size (1920×1080) before the moving-image improvement in the demo mode B.

The use of the same data for the demo modes A and B eliminates the need for storing still image data for each of these modes and reduces the required capacity of the ROM. That is, if the same still image data is stored in the ROM 13 for use in both the demo modes A and B, the required capacity of the ROM 13 can be reduced, resulting in lower cost.

As described above, according to the second embodiment, in the demo mode related to the super resolution conversion, the demo mode controller controls the demo mode to display a scrolling image so that the display state of the image changes from before to after the super resolution conversion. In the demo mode related to the moving-image improvement, the demo mode controller controls the demo mode to display a scrolling image so that the display state of the image changes from before to after the moving-image improvement. This facilitates to check the difference between images before and after the processing.

Moreover, the demo mode controller controls the speed of the scrolling display such that the screen is scrolled at low speed in the demo mode related to the super resolution conversion, while it is scrolled at high speed in the demo mode related to the moving-image improvement. This further facilitates to check the difference between images before and after the processing.

Next, a description will be given of the operation of the video display device 1 according to a third embodiment of the invention. In the third embodiment, when a salesperson (or a customer) selects either or both the demo mode (demo mode A) for displaying an image after the super resolution conversion and the demo mode (demo mode B) for displaying an image after the moving-image improvement, the selected demo mode is activated and the time is determined for which the demonstration is displayed.

According to the third embodiment, the demo mode controller 19 of the controller 10 functions differently than in the second embodiment. More specifically, in addition to the function described in the second embodiment, the demo mode controller 19 of the third embodiment controls the demo mode in response to selection made by a salesperson (or a customer) through the keyboard 14 or the remote controller 20.

FIG. 9 illustrates an example of a screen displayed on the display module 7 for selecting the demo mode. In the example of FIG. 9, a menu “Application” contains an item “Start Demo” to allow a salesperson (or a customer) to select “DEMO-A” (only the demo mode A is activated), “DEMO-B” (only the demo mode B is activated), or “Both” (both the demo modes A and B are activated) Otherwise, the video display device 1 of the third embodiment is of the same configuration and operates in a similar manner as previously described in the first embodiment, and the same description will not be repeated.

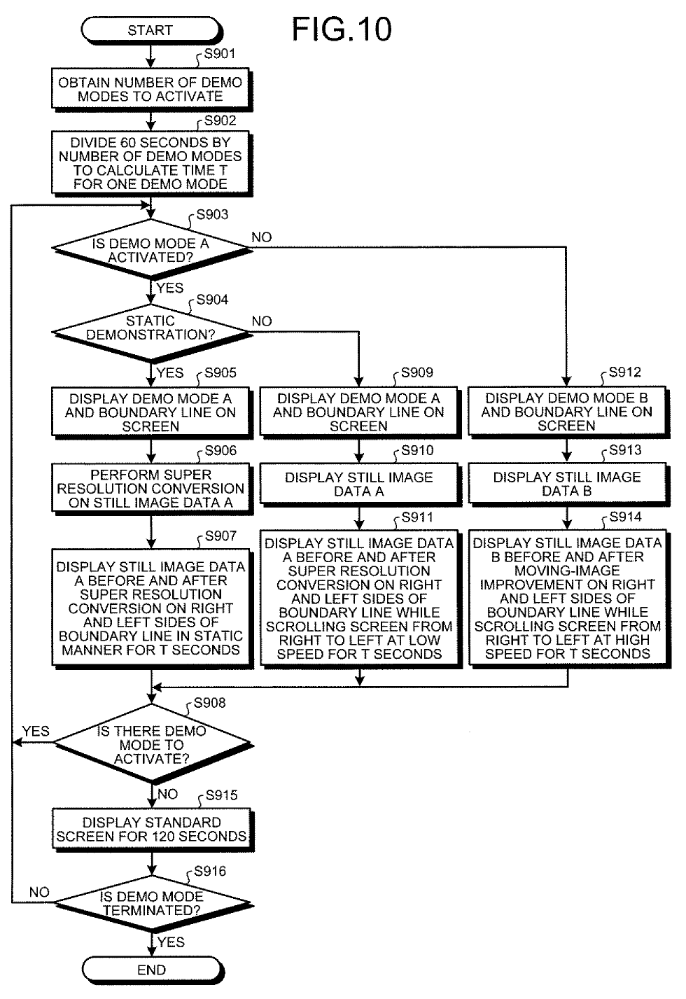

A description will be given of how the video display device 1 displays video in the demo mode according to the third embodiment. FIG. 10 is a flowchart of a process of demo mode control performed by the video display device 1 according to the third embodiment. The demo mode is activated in response to a start instruction from a salesperson or a customer. The demo mode may be automatically activated by preset “Auto Demo Mode”.

First, upon receiving selection as to the demo mode, the demo mode controller 19 obtains the number of the demo modes to activate from the selection (S901). For example, if “DEMO-A” or “DEMO-B” is selected, one demo mode is to be activated. Meanwhile, if “Both” is selected, two demo modes are to be activated.

The demo mode controller 19 divides the total time preset for performing the demonstration, e.g., 60 seconds, by the number of the demo modes to calculate time T (second) to be allocated to each of the demo modes (S902). Specifically, when either one of the demo mode A or B is activated, time T is 60 seconds When both the demo modes A and B are activated, time T is 30 seconds.

After that, the demo mode controller 19 determines whether to activate the demo mode A (S903). When the demo modes selected by a salesperson (or a customer) includes the demo mode A, the demo mode controller 19 determines to activate the demo mode A (Yes at S903). The demo mode controller 19 then further determines whether the demo mode A presents a static demonstration (S904).

Upon determining that the demo mode A presents a static demonstration (Yes at S904), the demo mode controller 19 instructs the display processor 6 to display the type of the demo mode, i.e., “Demo Mode A”, and a boundary line on the screen of the display module 7 (S905). For specific example, the display processor 6 displays “Demo Mode A” in the upper center of the screen and a boundary line that equally divides the screen into right and left halves. Further, the display processor 6 displays “OFF” on the lower part of the right half of the screen and “ON” on the lower part of the left half of the screen. On the screen indicating “OFF” is displayed an image not having undergone the super resolution conversion. On the screen indicating “ON” is displayed an image having undergone the super resolution conversion.

The demo mode controller 19 then instructs the super-resolution converter 17 to perform the super resolution conversion on the still image data A (S906). More specifically, the super-resolution converter 17 performs the super resolution conversion to increase the size of the still image data A stored in the RON 13 to the full high-definition size (1920×1080).

Thereafter, the demo mode controller 19 instructs the video processor 5 to display the still image data A before the super resolution conversion on the right side of the boundary line on the screen in a static manner for T seconds. Similarly, the demo mode controller 19 instructs the video processor 5 to display the still image data A after the super resolution conversion on the left side of the boundary line on the screen in a static manner for T seconds (S907). Thus, images as described in the first embodiment in connection with FIG. 4 are displayed on the screen of the display module 7. After T-second static display of the still image data A, the process moves to S908. If only the demo mode A is activated, T seconds=60 seconds. If both the demo modes A and B are activated, T seconds=30 seconds.

Upon determining that the demo mode A does not present a static demonstration, i.e., presents a scrolling demonstration (No at S904), the demo mode controller 19 instructs the display processor 6 to display the type of the demo mode, i.e., “Demo Mode A”, and a boundary line on the screen of the display module 7 (S909) For specific example, the display processor 6 displays “Demo Mode A” in the upper center of the screen and a boundary line that equally divides the screen into right and left halves. Further, the display processor 6 displays “OFF” on the lower part of the right half of the screen and “ON” on the lower part of the left half of the screen. On the screen indicating “OFF” is displayed an image not having undergone the super resolution conversion. On the screen indicating “ON” is displayed an image having undergone the super resolution conversion.

Thereafter, the demo mode controller 19 instructs the video processor 5 to display the still image data A (S910).

The demo mode controller 19 then instructs the super-resolution converter 17 to perform the super resolution conversion on the still image data A to display an image. Accordingly, half of the image is displayed in a state before the super resolution conversion on the right side of the boundary line on the screen, while the other half is displayed in a state after the super resolution conversion on the left side thereof. The image is displayed as being scrolled from right to left at low speed for T seconds (S911). Thus, the image as described in the second embodiment in connection with FIG. 8 is displayed on the screen of the display module 7. After T-second scrolling display of the still image data A, the process moves to S908. If only the demo mode A is activated, T seconds=60 seconds. If both the demo modes A and B are activated, T seconds=30 seconds.

The demo mode controller 19 determines whether there is demo mode to activate (S908). At this point, the demo mode B is yet to be activated. Therefore, if the demo modes selected by a salesperson (or a customer) includes the demo mode B, the demo mode controller 19 determines that there is demo mode to activate (Yes at S908), and the process returns to S903.

Upon determining not to activate the demo mode A because the demo mode A is not selected by the salesperson (or the customer) or has already been completed, i.e., to activate the demo mode B (Yes at S903), the demo mode controller 19 instructs the display processor 6 to display the type of the demo mode, i.e., “Demo Mode B”, and a boundary line on the screen of the display module 7 (S912).

Thereafter, the demo mode controller 19 instructs the video processor 5 to display the still image data B (S913).

The demo mode controller 19 then instructs the moving-image improving module 18 to perform the moving-image improvement on the still image data B to display an image. Accordingly, half of the image is displayed in a state before the moving-image improvement on the right side of the boundary line on the screen, while the other half is displayed in a state after the moving-image improvement on the left side thereof. The image is displayed as being scrolled from right to left at high speed for T seconds (S914). Thus, the image as described in the first embodiment in connection with FIG. 5 is displayed on the screen of the display module 7. After T-second scrolling display of the still image data B, the process moves to S908. If only the demo mode B is activated, T seconds=60 seconds. If both the demo modes A and B are activated, T seconds=30 seconds.

The demo mode controller 19 determines whether there is demo mode to activate (S908). When the demo mode controller 19 determines that there is no demo mode to activate (No at S908), the process moves to S915.

The demo mode controller 19 instructs the video processor 5 to display on the screen a standard screen as described in the first embodiment in connection with FIG. 6 for 120 seconds (S915). After 120-second display of the standard screen, the process moves to S916.

The demo mode controller 19 determines whether to terminate the demo mode (S916). The demo mode controller 19 makes the determination based on, for example, whether a predetermined time has elapsed. If the demo mode controller 19 determines to terminate the demo mode (Yes at S916), the process ends. On the other hand, if the demo mode controller 19 determines not to terminate the demo mode (No at S916), the process returns to S903, and the demo mode continues.

As described above, according to the third embodiment, the demo mode controller controls whether to activate each demo modes, and changes the operation time for each demo mode depending on the number of demo modes to activate. Thus, the demo modes can be effectively activated.

In the first to third embodiments, an image having undergone the super resolution conversion and that having undergone the moving-image improvement are separately demonstrated. However, this is by way of example only as an image having undergone the two types of processing may be demonstrated. For example, the demo mode may present scrolling display such that the state of an image changes from not having undergone any processing to having undergone both the super resolution conversion and the moving-image improvement. With this, it is possible to check the synergy of both processing results.

Besides, although the image used in the demo mode is described above as a JPEG still image, it may be a fixed pattern such as a color bar or an MPEG-2 moving image.

Further, although two types of demo modes are used in the first to third embodiments, there maybe three or more types of demo modes.

Still further, what are fixedly displayed on the screen are not limited to those described in the first to third embodiments. In addition, the direction of scrolling the image is not necessarily from right to left, and may be from left to right, or in the up/down direction.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video display device comprising:
a super resolution converter configured to perform, on receipt of a first video signal with first resolution, super resolution conversion on the first video signal to obtain a second video signal with second resolution that is higher than the first resolution by estimating an original pixel value from the first video signal and increasing pixels;
a moving-image improving module configured to perform moving-image improvement on the second video signal by high-precision motion interpolation to double frames of video per second; and
a demonstration mode controller configured to control activation of demonstration modes, the demonstration modes including first demonstration mode for displaying demonstration related to the super resolution conversion on a display module and second demonstration mode for displaying demonstration related to the moving-image improvement on the display module.

2. The video display device of claim 1, wherein
the demonstration mode controller is configured to control the first demonstration mode to concurrently display on the display module a video image obtained by scaling the first video signal and a video image obtained by scaling the first video signal and performing the super resolution conversion on the first video signal in a static manner, and
the demonstration mode controller is configured to control the second demonstration mode to display on the display module a video image represented by the second video signal and a video image obtained by performing the moving-image improvement on the second video signal so that the video images form one image in a scrolling manner.

3. The video display device of claim 1, wherein
the demonstration mode controller is configured to control the first demonstration mode to display on the display module a video image obtained by scaling the first video signal and a video image obtained by scaling the first video signal and performing the super resolution conversion on the first video signal so that the video images form one image in a scrolling manner, and
the demonstration mode controller is configured to control the second demonstration mode to display on the display module a video image represented by the second video signal and a video image obtained by performing the moving-image improvement on the second video signal so that the video images form one image in a scrolling manner.

4. The video display device of claim 1, wherein the demonstration mode controller is configured to determine whether to activate either or both the first demonstration mode and the second demonstration mode, and changes operation time of each of the demonstration modes according to number of demonstration modes to activate.

5. The video display device of claim 1, wherein, when activating both the first demonstration mode and the second demonstration mode, the demonstration mode controller activates the first demonstration mode and the second demonstration mode sequentially.

6. A video display device comprising:
a super resolution converter configured to perform, on receipt of a first video signal with first resolution, super resolution conversion on the first video signal to obtain a second video signal with second resolution that is higher than the first resolution by estimating an original pixel value from the first video signal and increasing pixels; and
a demonstration mode controller configured to control activation of demonstration mode for displaying demonstration related to the super resolution conversion on a display module.

7. A video display device comprising:
a super resolution converter configured to perform, on receipt of a first video signal with first resolution, super resolution conversion on the first video signal to obtain a second video signal with second resolution that is higher than the first resolution;
a moving-image improving module configured to perform moving-image improvement on the second video signal by high-precision motion interpolation to double frames of video per second; and
a demonstration mode controller configured to control activation of first demonstration mode for displaying demonstration related to the super resolution conversion on a display module and second demonstration mode for displaying demonstration related to the moving-image improvement on the display module.
